(19) United States
(12) Patent Application Publication
(10) Pub. No.: US 2011/0211550 A1
(43) Pub. Date: Sep. 1, 2011

(54) SPATIAL MULTIPLEXING SLOT ASSIGNMENT METHOD AND BASE STATION

(75) Inventor: Tomohiro Suzuki, Yokohama-shi (JP)

(73) Assignee: KYOCERA CORPORATION, Kyoto (JP)

(21) Appl. No.: 13/129,223

(22) PCT Filed: Nov. 26, 2009
(86) PCT No.: PCT/JP2009/006401

§ 371 Date: May 13, 2011

(30) Foreign Application Priority Data
Nov. 26, 2008 (JP) 2008-301370
Jan. 28, 2009 (JP) 2009-016780
Jan. 28, 2009 (JP) 2009-016872

(51) Int. Cl. H04W 72/04

(52) U.S. Cl. 370/329

(57) ABSTRACT

Frequency usage efficiency of the entire system is improved by assigning subslots to all communication calls from terminals with low frequency usage efficiency. A base station for communicating with a plurality of terminals by a spatial multiple slot assignment method includes a reception unit for receiving an access request transmitted from the terminal and a control unit (A), based on the access request, for assigning a slot to the terminal by a subslot scheme or assigning a slot to the terminal by a full slot scheme.

### CROSS REFERENCE TO RELATED APPLICATIONS

This application claims priority to and the benefit of Japanese Patent Application No. 2008-301370 (filed on Nov. 26, 2008), Japanese Patent Application No. 2009-16872 (filed on Jan. 28, 2009) and Japanese Patent Application No. 2009-16780 (filed on Jan. 28, 2009), the entire contents of which are incorporated herein by reference.

### TECHNICAL FIELD

The present invention relates to spatial multiplexing slot assignment methods and base stations.

### BACKGROUND ART

According to the conventional spatial multiplexing scheme, a base station having an adaptive array antenna system (hereinafter, referred to as an “adaptive array base station”) is configured to reject a new request after the maximum spatial multiplexing order has been reached. In addition, if the base station spatially multiplexes all of calls, an appropriate service grade and spatial multiplexing may not be maintained for each of the calls. In order to deal with that, there is suggested a conventional scheme (see Patent Document 1) to provide an appropriate service grade by categorizing calls by level and determining whether to perform spatial multiplexing on the calls.

### PRIOR ART DOCUMENT

### Patent Document

Patent Document 1: Japanese Patent Laid-Open No. 2002-58061

### SUMMARY OF INVENTION

### Technical Problem

However, although capable of providing an appropriate service grade to a call, the above scheme still cannot allow an access of a new call if the spatial multiplexing order reaches the maximum. It is particularly problematic here that it rejects an access of a call equally even from a terminal (hereinafter, referred to as a “narrowband call terminal”) requesting high immediacy such as VoIP (Voice Over IP=narrowband call). In addition, although the wireless communication quality of a user terminal distant from the base station (hereinafter, referred to as a “distant terminal”) or a user terminal moving at a high speed (hereinafter, referred to as a “fast moving terminal”) is generally liable to vary, the above scheme does not solve a problem how to assign spatial multiplexing slots to such terminals.

Hence, the present applicant developed a technique, upon reception of a new access request if the maximum spatial multiplexing order has been reached, to accept the new access request by using a subslot scheme, and thereby a call from a narrowband call terminal such as VoIP can be accepted without rejection and a spatial multiplexing slot can be appropriately assigned to a call from a distant terminal or a fast moving terminal (Japanese Patent Application No. 2007-222902, Japanese Patent Application No. 2008-081785). FIG. 8 to FIG. 10 show a configuration diagram and flowcharts of an apparatus according to the technique developed by the present applicant. However, since subslots are assigned to new narrowband call terminals, fast moving terminals and distant terminals only after the maximum spatial multiplexing order has been reached, even the technique by the present applicant assigns full slots to the narrowband call terminals such as VoIP user terminals, which should be assigned with subslots, until the maximum spatial multiplexing order is reached. Thereby, it deteriorates frequency usage efficiency of overall system, as incapable of assigning a necessary resource to a broadband call user. In addition, since the technique uniformly assigns subslots to fast moving terminals and distant terminals after the maximum spatial multiplexing order is reached, it cannot control in consideration of difference in the wireless quality of each terminal to assign full slots to the distant terminals and the fast moving terminals with good wireless conditions.

Accordingly, it is an object of the present invention to provide a spatial multiplexing slot assignment method and a base station capable of improving user convenience and the frequency usage efficiency by assigning a full slot or a subslot to a communication call based on a state of a terminal, such as the narrowband call terminal of VoIP or the like, the distant terminal or the fast moving terminal, and the wireless quality with the terminal.

### Solution to Problem

In order to solve the above problems, a spatial multiplexing slot assignment method according to a first invention is a spatial multiplexing slot assignment method of a base station for communicating with a plurality of terminals, including the steps of:

receiving an access request transmitted from a terminal;

determining at least one of a state of the terminal and wireless quality of the access request based on the access request; and

controlling assignment to assign a slot to the terminal by a subslot scheme or a full slot scheme in accordance with a result of determination at the step of determining.

The spatial multiplexing slot assignment method according to a second invention is that in the spatial multiplexing slot assignment method according to the first invention,

the step of determining comprises determining whether the access request indicates that a call of the terminal is a narrowband call, indicates that the terminal is moving at a predetermined speed or faster, or indicates that the terminal is distant from the base station by a predetermined distance or further, and

the step of controlling assignment comprises assigning a slot to the terminal by the subslot scheme if it is determined at the step of determining that the call of the terminal is the narrowband call, that the terminal is moving at the predetermined speed or faster, or that the terminal is distant from the base station by the predetermined distance or further, otherwise assigning a slot to the terminal by the full slot scheme.

The spatial multiplexing slot assignment method according to a third invention is that in the spatial multiplexing slot assignment method according to the first invention,

the step of determining comprises determining whether the access request indicates that a call of the terminal is a narrowband call or whether a value indicating wireless quality of the access request is equal to or under a predetermined value, and

the step of controlling assignment comprises assigning a slot to the terminal by the subslot scheme if it is determined at the step of determining that the call of the terminal is the narrowband call or that the value indicating the wireless quality of the access request is equal to or under the predetermined value, otherwise assigning a slot to the terminal by the full slot scheme.

The spatial multiplexing slot assignment method according to a fourth invention is that in the spatial multiplexing slot assignment method according to the first invention,

the step of determining comprises determining whether the access request indicates that a call of the terminal is a narrowband call, indicates that the terminal is moving at a predetermined speed or faster, or indicates that the terminal is distant from the base station by a predetermined distance or further, or whether a value indicating wireless quality of the access request is equal to or under a predetermined value, and

the step of controlling assignment comprises assigning a slot to the terminal by the subslot scheme
if it is determined at the step of determining that the call of the terminal is the narrowband call, or
if it is determined that the terminal is moving at the predetermined speed or faster or that the terminal is distant from the base station by the predetermined distance or further, and it is determined that the value indicating the wireless quality of the access request is equal to or under the predetermined value,

otherwise assigning a slot to the terminal by the full slot scheme.

The spatial multiplexing slot assignment method according to a fifth invention in that in the spatial multiplexing slot assignment method according to one of the first to the fourth inventions, further includes the step of:

managing subslots, in assigning a slot to the terminal by the subslot scheme, wherein a full slot is divided into a plurality of subslots, to determine whether there is a vacant subslot unused, while a part of subslots is in use among the plurality of subslots, in spatial multiplexing slots of the base station, wherein

the step of controlling assignment comprises assigning the vacant subslot to the terminal if it is determined at the step of managing subslots that there is the vacant subslot.

In order to solve the above problems, a base station according to a sixth invention is a base station for communicating with a plurality of terminals by a spatial multiplexing slot assignment scheme, including:

a reception unit for receiving an access request transmitted from a terminal; and

a control unit for assigning a slot to the terminal by a subslot scheme or a full slot scheme in response to the access request.

The base station according to a seventh invention is that in the base station according to the sixth invention,

the control unit assigns a slot to the terminal by the subslot scheme if the access request indicates that a call of the terminal is a narrowband call, indicates that the terminal is moving at a predetermined speed or faster, or indicates that the terminal is distant from the base station by a predetermined distance or further, otherwise assigns a slot to the terminal by the full slot scheme.

The base station according to an eight invention is that in the base station according to the sixth invention,

the control unit assigns a slot to the terminal by the subslot scheme if the access request indicates that a call of the terminal is a narrowband call or if a value indicating wireless quality of the access request is equal to or under a predetermined value, otherwise assigns a slot to the terminal by the full slot scheme.

The base station according to a ninth invention is that in the base station according to the sixth invention, the control unit assigns a slot to the terminal by the subslot scheme
if the access request indicates that a call of the terminal is a narrow band call, or
if the access request indicates that the terminal is moving at a predetermined speed or faster or indicates that the terminal is distant from the base station by a predetermined distance or further, and a value indicating wireless quality of the access request is equal to or under a predetermined value,

otherwise assigns a slot to the terminal by the full slot scheme.

The base station according to a tenth invention is that in the base station according to one of the sixth to the ninth inventions,

the control unit, in assigning a slot to the terminal by the subslot scheme, wherein a full slot is divided into a plurality of subslots, if there is a vacant subslot unused while a part of subslots is in use among the plurality of subslots, in spatial multiplexing slots of the base station, controls to assign the vacant subslot to the terminal.

### EFFECT OF THE INVENTION

According to the preset invention, it is expected to dramatically improve frequency usage efficiency of the entire system by controlling slot assignment based on a condition of a terminal and a wireless communication state such that all communication calls from terminals with low frequency usage efficiency are assigned subslots and other terminals of normal data users are assigned full slots.

### BRIEF DESCRIPTION OF DRAWINGS

FIG. 1 is a block diagram illustrating an adaptive array base station according to a first embodiment of the present invention;

FIG. 2 is a flowchart illustrating spatial multiplexing slot assignment algorithm processing (method) according to the first embodiment of the present invention;

FIG. 3 is a block diagram illustrating an adaptive array base station according to a second embodiment of the present invention;

FIG. 4 is a flowchart illustrating spatial multiplexing slot assignment algorithm processing (method) according to the second embodiment of the present invention;

FIG. 5 is a block diagram illustrating an adaptive array base station according to a third embodiment of the present invention;

FIG. 6 is a flowchart illustrating spatial multiplexing slot assignment algorithm processing (method) according to the third embodiment of the present invention;

FIG. 7 is a timing chart illustrating an exemplary subslot scheme according to the present invention;

FIG. 8 is a configuration diagram of an adaptive array base station according to a conventional art;

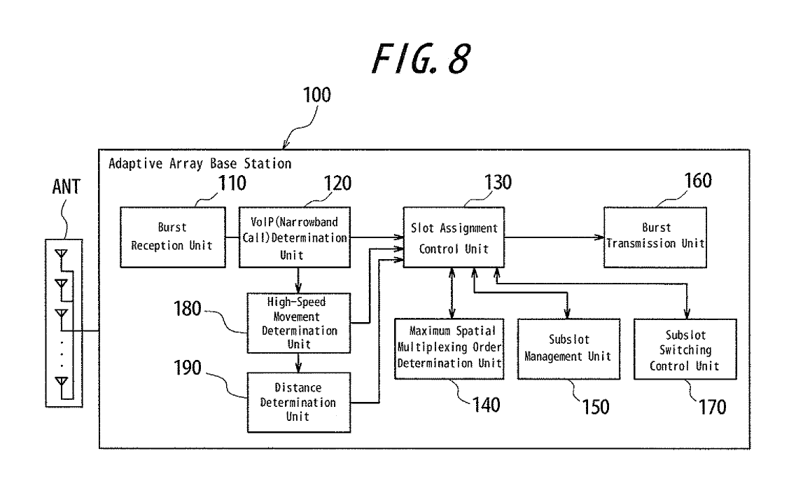

FIG. 9 is a flowchart illustrating processing in response to an access request to the adaptive array base station according to the conventional art; and

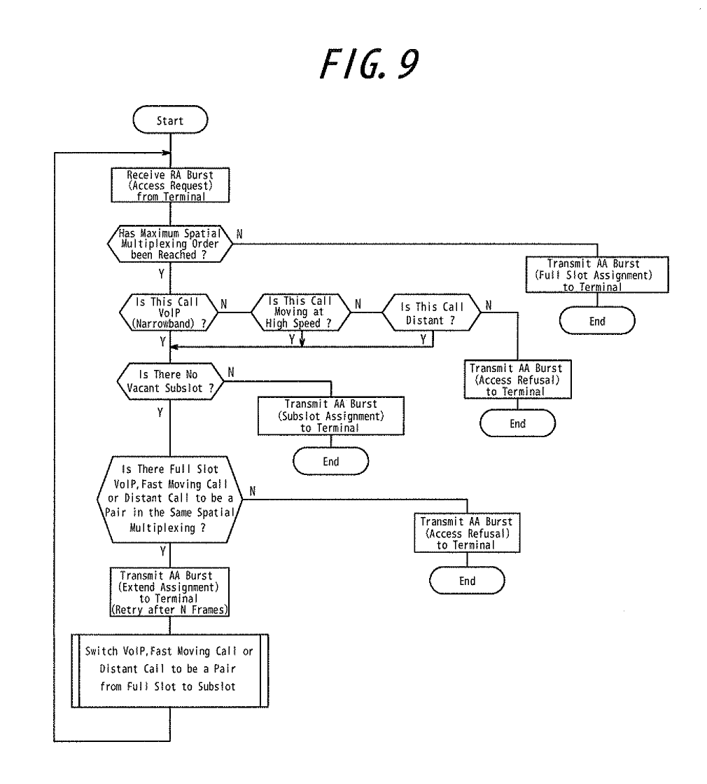

FIG. 10 is a flowchart illustrating processing in response to an access request to the adaptive array base station according to the conventional art.

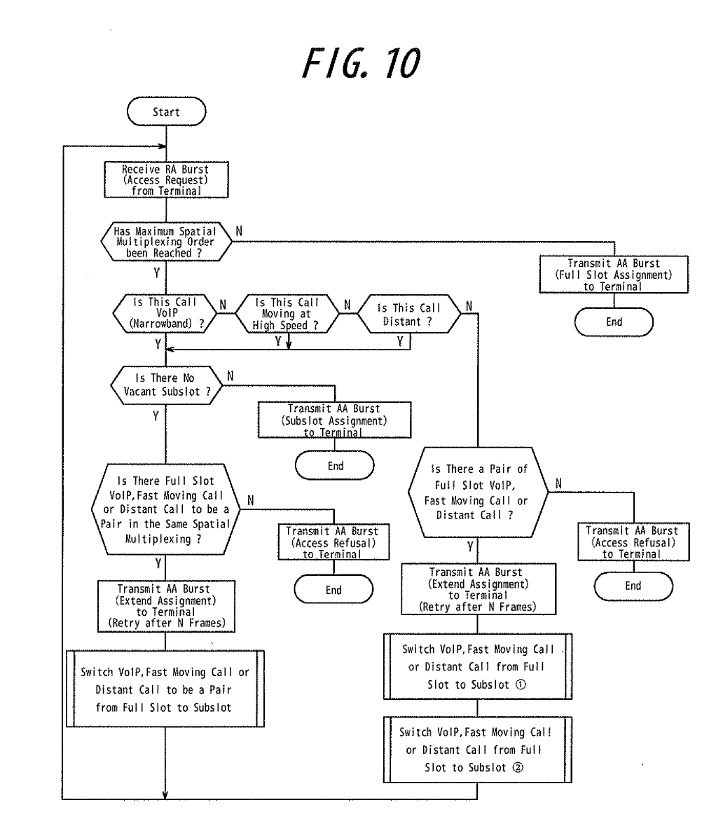

### DESCRIPTION OF EMBODIMENTS

Embodiments of the present invention will be described with reference to the accompanying drawings.

### First Embodiment

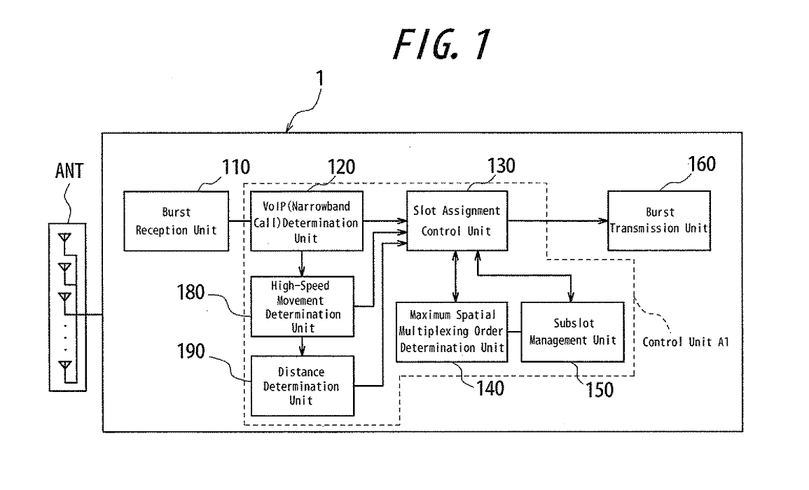

FIG. 1 is a block diagram illustrating an adaptive array base station according to a first embodiment of the present invention. As shown in the figure, an adaptive array base station 1 includes a burst reception unit 110 for receiving an RA burst, a VoIP (narrowband call) determination unit 120 for determining whether it is a VoIP (narrowband call), a high-speed movement determination unit 180 for determining whether a terminal is moving at a high speed, a distance determination unit 190 for determining whether the terminal is distant from the base station itself (adaptive array base station 1), a slot assignment control unit 130 for controlling slot assignment, a maximum spatial multiplexing order determination unit 140 for managing the maximum spatial multiplexing order and determining whether the maximum spatial multiplexing order is reached, a subslot management unit 150, and a burst transmission unit 160 for transmitting an AA burst. The VoIP (narrowband call) determination unit 120, the high-speed movement determination unit 180 and the distance determination unit 190 are referred to as a “determination unit” collectively. In addition, the VoIP (narrowband call) determination unit 120, the high-speed movement determination unit 180, the distance determination unit 190, the slot assignment control unit 130, the maximum spatial multiplexing order determination unit 140 and the subslot management unit 150 are included in a control unit A1 implemented mainly by a processor such as a CPU (Central Processing Unit) or the like. The adaptive array base station 1 further includes an adaptive array antenna ANT constituted of a plurality of antennas.

Next, the data flow will be described. First, when the RA burst (access request) is transmitted from a terminal (not shown) to a base station 1, the burst reception unit 110 of the base station 1 receives the RA burst. Then, the VoIP (narrowband call) determination unit 120 reads a VoIP (narrowband call) bit pre-embedded in the RA burst and determines whether the terminal is a narrow band call terminal such as a VoIP terminal or the like (that is, whether it indicates that a call of the terminal is a narrowband call). When a terminal performs registration, a terminal identification number ID is assigned to the terminal, and it may be already determined at the registration whether the call is a broadband call or a narrowband call, and alternatively it may be designated by the terminal. In such cases, the terminal needs not to insert the VoIP (narrowband call) bit in the RA burst to transmit to the base station but may insert the terminal identification number ID at registration, such that the VoIP (narrowband call) determination unit 120 can determine between the wideband call and the narrowband call by using the terminal identification number ID. If a result of determination by the VoIP (narrowband call) determination unit 120 indicates that the terminal is not a narrowband call terminal, the high-speed movement determination unit 180 reads a high-speed movement bit pre-embedded in the RA burst and determines whether the terminal is moving at a high speed (that is, whether the terminal is moving at a predetermined speed or faster). For example, the high-speed movement determination unit 180 may determine whether the terminal is moving at a high speed based on phase variations of a plurality of known signals included in a wireless frame or may make a determination using a fading speed (equivalent to the a moving speed) estimation method. If a result of the high-speed movement determination unit 180 indicates that the terminal is not a fast moving terminal, the distance determination unit the terminal is distant from the base station (that is, whether the terminal is distant from the base station (adaptive array base station 1) by a predetermined distance or further). The distance determination unit 190 may determine whether the terminal is distant from the base station, based on information used for directivity control of the array antenna ANT obtained while communicating with the terminal or transmission power to the terminal. In addition, the distance determination unit 190 may determine whether the terminal is distant from the base station (adaptive array base station 1), based on information transmitted from the terminal such as information on a propagation delay time of a reception signal the terminal receives or information on a distance from the base station calculated from the propagation delay time. Moreover, the distance determination unit 190 may determine whether the terminal is distant from the base station based on location information by GPS transmitted from the terminal. Next, the slot assignment control unit 130 controls slot assignment by using a spatial multiplexing slot assignment algorithm (method), which will be described below, with reference to information of the maximum spatial multiplexing order determination unit 140 and the subslot management unit 150.

Next, the burst transmission unit 160 informs the terminal of a result of assignment. Here, a “full slot” has a normal slot configuration. In contrast, the “subslot” has a slot configuration dividing a “full slot” into halves to be time-shared by a pair of (two) users, for example, in need of only a narrowband such as VoIP. As a time sharing method, there may be a method which alternately uses even frames and odd frames between two users, and a method which divides a slot into a first half and a last half and uses them for two users. The full slot and the subslot will be described in detail below.

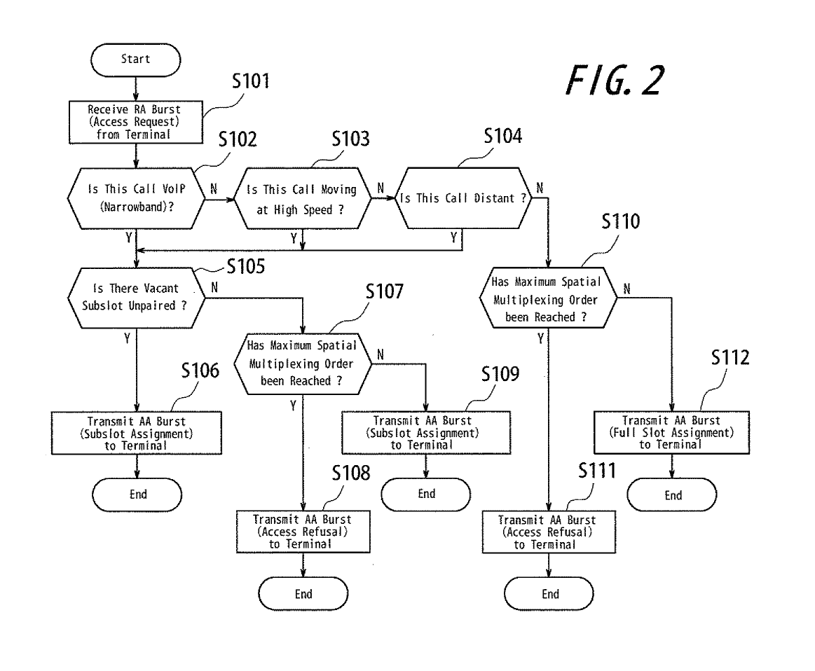

FIG. 2 is a flowchart illustrating the spatial multiplexing slot assignment algorithm (method) according to the first embodiment of the present invention. As shown in the figure, at step S101, first, the burst reception unit 110 of the base station 1 (a communication apparatus responsible for control of the slot assignment and spatial multiplexing) receives the RA burst (access request) from the terminal. Next, the VoIP (narrowband call) determination unit 120 determines whether the terminal is a narrowband call terminal by reading the VoIP (narrowband call) bit pre-embedded in the RA burst (step S102). If a result of determination by the VoIP (narrowband call) determination unit 120 indicates that the terminal is not a narrowband call terminal, the high-speed movement determination unit 180 determines whether the terminal is a fast moving terminal by reading the high-speed movement bit pre-embedded in the RA burst (step S103). If a result of determination by the high-speed movement determination unit 180 indicates that the terminal is not a fast moving terminal, the distance determination unit 190 determines whether the terminal is a distant terminal by reading the distance access bit pre-embedded in the RA burst (step S104).

If it is determined at any of steps S102-S104 that the terminal is any of the narrowband call terminal, the fast moving terminal and the distant terminal, the slot assignment control unit 130 controls to assign a subslot to the terminal. In this case, the subslot management unit 150 determines whether there is a vacant subslot unused (vacant subslot unpaired), while another subslot is used for another narrowband call, among a plurality of subslots (for example, two) in a full slot (step S105). If there is a vacant subslot unpaired, the slot assignment control unit 130 controls the burst transmission unit 160 to transmit the AA burst (subslot assignment) to the terminal to assign the vacant subslot to the terminal (step S106) and then ends the assignment algorithm processing.

If there is no vacant subslot unpaired at step S105, the maximum spatial multiplexing order determination unit 140 determines whether carrier frequencies at reception of the RA burst from the terminal have reached the maximum spatial multiplexing order (step S107). If it has not reached the maximum spatial multiplexing order, the slot assignment control unit 130 shifts to step S109 to control the burst transmission unit 160 to transmit the AA burst (subslot assignment) to the terminal to assign any vacant subslot to the terminal and ends the assignment algorithm processing. In contrast, if it is determined at step S107 that it has reached the maximum spatial multiplexing order, the slot assignment control unit 130 controls the burst transmission unit 160 to transmit the AA burst (access refusal) to the terminal to refuse the access of the terminal (step S108) and ends the assignment algorithm processing.

If it is determined that the terminal is not any of the narrowband call terminal, the fast moving terminal and the distant terminal (that is, the call from the terminal is a broadband call in need of full slot assignment) at steps S102-S104, the maximum spatial multiplexing order determination unit 140 determines whether the carrier frequencies at reception of the RA burst from the terminal have reached the maximum spatial multiplexing order (step S110). If they have not reached the maximum spatial multiplexing order, the slot assignment control unit 130 shifts to step S112 to control the burst transmission unit 160 to transmit the AA burst (full slot assignment) to the terminal to assign a full slot to the terminal and ends the assignment algorithm processing. In contrast, if it is determined at step S110 that they have reached the maximum spatial multiplexing order, the slot assignment control unit 130 controls the burst transmission unit 160 to transmit the AA burst (access refusal) to the terminal to refuse the access of the terminal (step S111) and ends the assignment algorithm processing.

According to the present embodiment, as stated above, the slot assignment is restricted such that all of communication calls from VoIP (narrowband call) terminals with low frequency usage efficiency, fast moving terminals and distant terminals are assigned subslots, while other normal data user terminals are assigned full slots. Thereby, it is expected to dramatically improve the frequency usage efficiency of the entire system. In addition, since only the subslots will be influenced by interference by the fast moving terminal and the distant terminal, it is expected to slightly improve the frequency usage efficiency in the spatial multiplexing slot. Moreover, it eliminates the need for a subslot switching process, which leads to reduction in the processing load.

### Second Embodiment

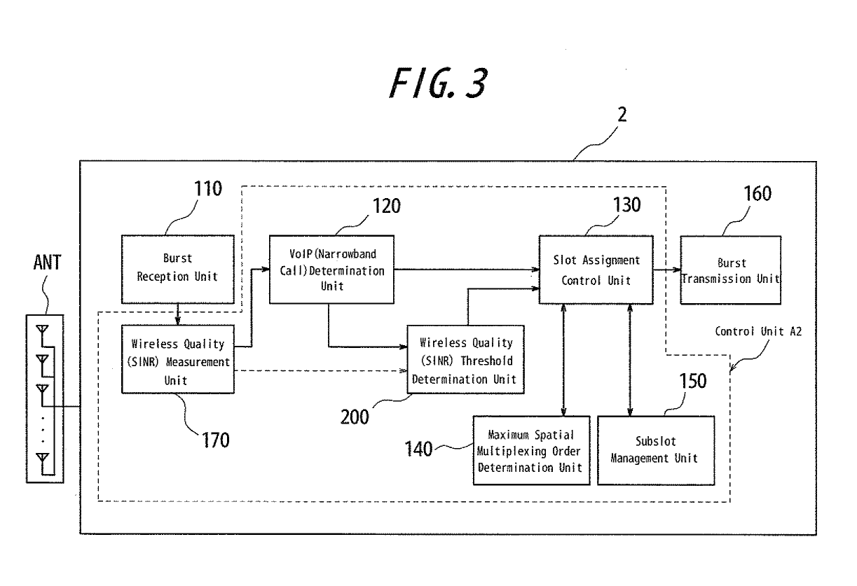

FIG. 3 is a block diagram illustrating an adaptive array base station according to a second embodiment of the present invention. As shown in the figure, an adaptive array base station 2 includes a burst reception unit 110 for receiving RA burst, a wireless quality (SINR) measurement unit 170 for measuring a value (for example, SINR: Signal-to-Interference and Noise power Ratio) indicating a wireless quality of the RA burst (access request), a VoIP (narrowband call) determination unit 120 for determining whether it is the VoIP (narrowband call), a wireless quality (SINR) threshold determination unit 200 for determining whether the value indicating the wireless quality of the RA burst (access request) is equal to or under a predetermined threshold, a slot assignment control unit 130 for controlling the slot assignment, a maximum spatial multiplexing order determination unit 140 for managing the maximum spatial multiplexing order and determining whether the maximum spatial multiplexing order is reached, a subslot management unit 150, and a burst transmission unit 160 for transmitting the AA burst. The VoIP (narrowband call) determination unit 120 and the wireless quality (SINR) threshold determination unit 200 are referred to as the “determination unit” collectively. In addition, the wireless quality (SINR) measurement unit 170, the VoIP (narrowband call) determination unit 120, the wireless quality (SINR) threshold determination unit 200, the slot assignment control unit 130, the maximum spatial multiplexing order determination unit 140 and the subslot management unit 150 are included in a control unit A2 implemented mainly by a processor such as CPU (Central Processing Unit) or the like. The adaptive array base station 2 further includes an adaptive array antenna ANT constituted of a plurality of antennas.

Next, the data flow will be described. First, when the RA burst (access request) is transmitted from a terminal (not shown) to a base station 2, the burst reception unit 110 of the base station 2 receives the RA burst. Upon reception of the RA burst, the wireless quality (SINR) measurement unit 170 measures a value (for example, SINR) indicating the wireless quality of the RA burst. It is to be noted that not only SINR but any wireless value may be used as the value indicating the wireless quality. The wireless quality (SINR) measurement unit 170 may measure (obtain) the wireless quality by, for example, reading a wireless quality value pre-embedded in the RA burst. Next, the VoIP (narrowband call) determination unit 120 reads the VoIP (narrowband call) bit pre-embedded in the RA burst and determines whether the terminal is a narrow band call terminal such as the VoIP terminal (that is, whether it indicates that the call of the terminal is a narrowband call). When a terminal performs registration, a terminal identification number ID is assigned to the terminal, and it may be already determined at the registration whether the call is a broadband call or a narrowband call, and alternatively it may be designated by the terminal. In such cases, the terminal needs not to insert the VoIP (narrowband call) bit in the RA burst to transmit to the base station but may insert the terminal identification number ID at registration, such that the VoIP (narrowband call) determination unit 120 can determine between the broadband call and the narrowband call based on the terminal identification number ID. If a result of determination by the VoIP (narrowband call) determination unit 120 indicates that the terminal is not a narrowband call terminal, the wireless quality (SINR) threshold determination unit 200 determines whether the value indicating the wireless quality of the RA burst measured by the wireless quality (SINR) measurement unit 170 is equal to or under a predetermined threshold. Next, the slot assignment control unit 130 controls the slot assignment by using the spatial multiplexing slot assignment algorithm (method), which will be described in detail below, with reference to the information of the maximum spatial multiplexing order determination unit 140 and the subslot management unit 150.

Next, the burst transmission unit 160 informs the terminal of a result of assignment. Here, the “full slot” has the normal slot configuration. In contrast, the “subslot” has the slot configuration dividing a “full slot” into halves to be time-shared by a pair of (two) users, for example, in need of only the narrowband such as VoIP. As the time sharing method, there may be a method which alternately uses even frames and odd frames between the two users or a method which divides a slot into a first half and a last half and uses them for two users. The full slot and the subslot will be described in detail below.

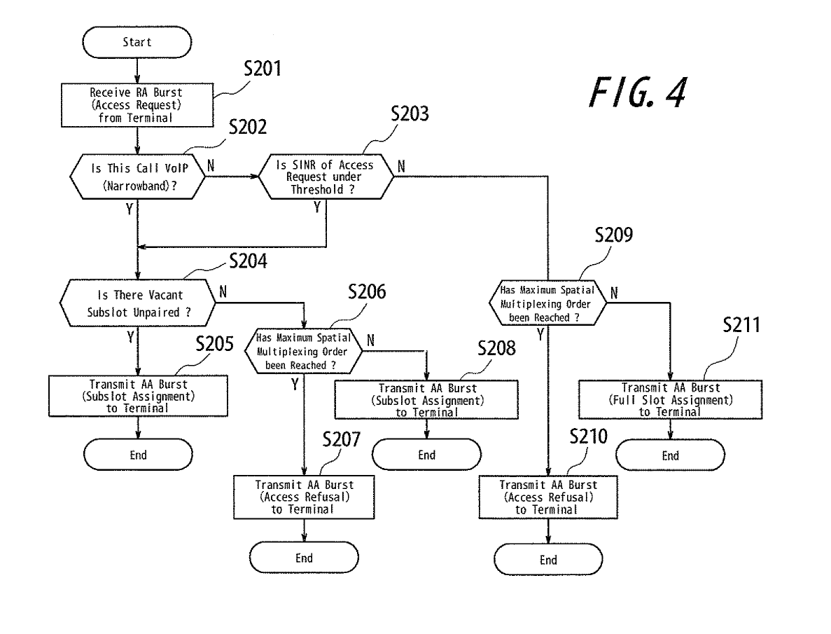

FIG. 4 is a flowchart illustrating a spatial multiplexing slot assignment algorithm (method) according to a second embodiment of the present invention. As shown in the figure, at step S201, first, the burst reception unit 110 of the base station 2 (the communication apparatus for controlling the slot assignment and the spatial multiplexing) receives the RA burst (access request) from the terminal, and the wireless quality (SINR) measurement unit 170 measures the value (for example, SINR) indicating the wireless quality of the RA burst. Next, the VoIP (narrowband call) determination unit 120 determines whether the terminal is a narrowband call terminal by reading the VoIP (narrowband call) bit pre-embedded in the RA burst (step S202). If a result of determination by the VoIP (narrowband call) determination unit 120 indicates that the terminal is not a narrowband call terminal, the wireless quality (SINR) threshold determination unit 200 determines whether the value indicating the wireless quality of the RA burst measured by the wireless quality (SINR) measurement unit 170 is equal to or under the predetermined threshold (step S203).

If it is determined at step S202 that the terminal is a narrowband call terminal or if it is determined at step S203 that the value of the wireless quality is equal to or under the predetermined threshold, the slot assignment control unit 130 controls to assign a subslot to the terminal. In this case, the subslot management unit 150 determines whether there is a vacant subslot unused (vacant subslot unpaired), while another subslot is used for another narrowband call, among a plurality of subslots (for example, two) in a full slot (step S204). If there is a vacant subslot unpaired, the slot assignment control unit 130 controls the burst transmission unit 160 to transmit the AA burst (subslot assignment) to the terminal to assign the vacant subslot to the terminal (step S205) and then ends the assignment algorithm processing.

If there is no vacant subslot unpaired at step S204, the maximum spatial multiplexing order determination unit 140 determines whether the carrier frequencies at reception of the RA burst from the terminal have reached the maximum spatial multiplexing order (step S206). If they have not reached the maximum spatial multiplexing order, the slot assignment control unit 130 shifts to step S208 to control the burst transmission unit 160 to transmit the AA burst (subslot assignment) to the terminal to assign any vacant subslot to the terminal and ends the assignment algorithm processing. In contrast, if it is determined at step S206 that they have reached the maximum spatial multiplexing order, the slot assignment control unit 130 controls the burst transmission unit 160 to transmit the AA burst (access refusal) to the terminal to refuse the access of the terminal (step S207) and ends the assignment algorithm processing.

If it is determined at step S202 that the terminal is not a narrowband call terminal and, additionally, if it is determined at step S203 that the value of the wireless quality satisfies the predetermined threshold (that is, if the call from the terminal is a broadband call in need of the full slot assignment and it is possible to assign the full slot in consideration of the wireless quality), the maximum spatial multiplexing order determination unit 140 determines whether the carrier frequencies at reception of the RA burst from the terminal have reached the maximum spatial multiplexing order (step S209). If they have not reached the maximum spatial multiplexing order, the slot assignment control unit 130 shifts to step S211 to control the burst transmission unit 160 to transmit the AA burst (full slot assignment) to the terminal to assign a full slot to the terminal and ends the assignment algorithm processing. In contrast, if it is determined at step S209 that they have reached the maximum spatial multiplexing order, the slot assignment control unit 130 controls the burst transmission unit 160 to transmit the AA burst (access refusal) to the terminal to refuse the access of the terminal (step S210) and ends the assignment algorithm processing.

According to the present embodiment, as described above, the slot assignment is restricted such that all of communication calls from the VoIP (narrowband call) terminals with low frequency usage efficiency and from the terminals with low wireless quality are assigned subslots, while other normal data user terminals are assigned full slots. Thereby, it is expected to dramatically improve the frequency usage efficiency of the entire system.

In addition according to the present embodiment, since all of the communication calls from terminals with low wireless quality are assigned subslots, it is possible to reduce interference by these terminals to other terminals. Hence, it is expected to improve the frequency usage efficiency of the entire system.

### Third Embodiment

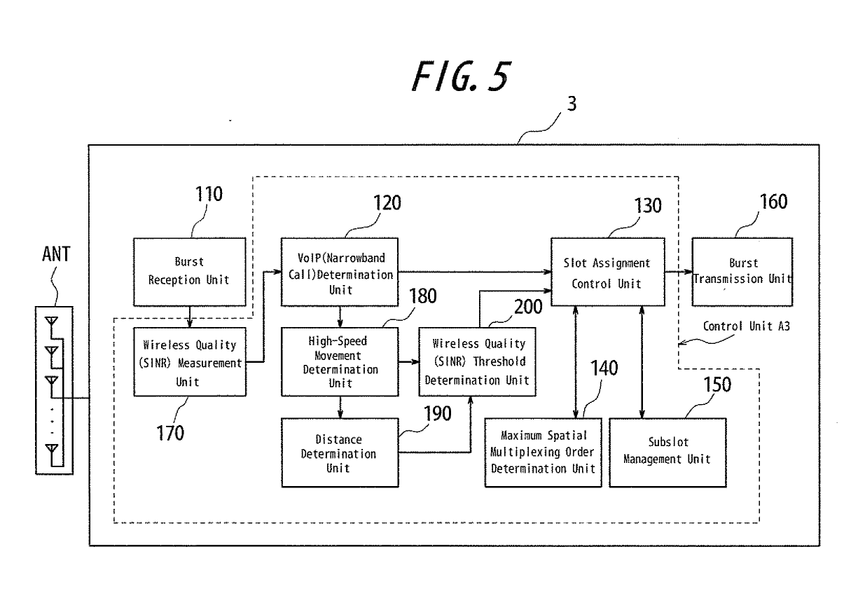

FIG. 5 is a block diagram illustrating an adaptive array base station according to a third embodiment of the present invention. As shown in the figure, an adaptive array base station 3 includes a burst reception unit 110 for receiving RA burst, a wireless quality (SINR) measurement unit 170 for measuring a value (for example, SINR: Signal-to-Interference and Noise power Ratio) indicating wireless quality of the RA burst (access request), a VoIP (narrowband call) determination unit 120 for determining whether it is a VoIP (narrowband call), a high-speed movement determination unit 180 for determining whether a terminal is moving at a high speed, a distance determination unit 190 for determining whether the terminal is distant from the base station (adaptive array base station 3), a wireless quality (SINR) threshold determination unit 200 for determining whether the value indicating the wireless quality of the RA burst (access request) is equal to or under a predetermined threshold, a slot assignment control unit 130 for controlling the slot assignment, a maximum spatial multiplexing order determination unit 140 for managing the maximum spatial multiplexing order and determining whether the maximum spatial multiplexing order is reached, a subslot management unit 150, and a burst transmission unit 160 for transmitting the AA burst. The VoIP (narrowband call) determination unit 120, the high-speed movement determination unit 180, the distance determination unit 190 and the wireless quality (SINR) threshold determination unit 200 are referred to as the “determination unit” collectively. In addition, the wireless quality (SINR) measurement unit 170, the VoIP (narrowband call) determination unit 120, the high-speed movement determination unit 180, the distance determination unit 190, the wireless quality (SINR) threshold determination unit 200, the slot assignment control unit 130, the maximum spatial multiplexing order determination unit 140 and the subslot management unit 150 are included in a control unit A3 implemented mainly by a processor such as CPU (Central Processing Unit) or the like. The adaptive array base station 3 further includes an adaptive array antenna ANT constituted of a plurality of antennas.

Next, the data flow will be described. First, when the RA burst (access request) is transmitted from the terminal (not shown) to a base station 3, the RA burst is received by the burst reception unit 110 of the base station 3. Upon reception of the RA burst, the wireless quality (SINR) measurement unit 170 measures a value (for example, SINR) indicating the wireless quality of the RA burst. It is to be noted that not only SINR but any wireless value may be used as the value indicating the wireless quality. The wireless quality (SINR) measurement unit 170 may measure (obtain) the wireless quality by, for example, reading a wireless quality value pre-embedded in the RA burst. Next, the VoIP (narrowband call) determination unit 120 reads the VoIP (narrowband call) bit pre-embedded in the RA burst and determines whether the terminal is a narrowband call terminal such as the VoIP terminal (that is, whether it indicates that the call of the terminal is a narrowband call). When a terminal performs, a terminal identification number ID is assigned to the terminal, and it may be already determined at the registration whether the call is a broadband call and a narrowband call, and alternatively it may be designated by the terminal. In such cases, the terminal needs not to insert the VoIP (narrowband call) bit into the RA burst to transmit to the base station but may insert the terminal identification number ID at registration, such that the VoIP (narrowband call) determination unit 120 can determine whether the call is a broadband call or a narrowband call based on the terminal identification number ID. If a result of determination by the VoIP (narrowband call) determination unit 120 indicates that the terminal is not a narrowband call terminal, the high-speed movement determination unit 180 reads the high-speed movement bit pre-embedded in the RA burst and determines whether the terminal is moving at a high speed (that is, whether the terminal is moving at a predetermined speed or faster). The high-speed movement determination unit 180 may determine whether the terminal is moving at a high speed based on, for example, phase variations of a plurality of known signals included in a wireless frame or may make a determination using the fading speed (equivalent to the moving speed) estimation method. If a result of the high-speed movement determination unit 180 indicates that the terminal is not a fast moving terminal, the distance determination unit 190 reads the distance access bit pre-embedded in the RA burst and determines whether the terminal is distant from the base station (that is, whether it indicates that the terminal is distant from the base station (adaptive array base station 3) by a predetermined distance or further). The distance determination unit 190 may determine whether the terminal is distant from the base station, based on information used for directivity control of the array antenna ANT obtained while communicating with the terminal or the transmission power to the terminal. In addition, the distance determination unit 190 may determine whether the terminal is distant from the base station based on information transmitted from the terminal such as information on the propagation delay time of the reception signal the terminal receives or information on the distance from the base station (adaptive array base station 3) calculated from the propagation delay time. Moreover, the distance determination unit 190 may determine whether the terminal is at a long distance based on the location information by the GPS and the like transmitted from the terminal. If it is determined by the high-speed movement determination unit 180 that the terminal is moving at a high speed or if it is determined by the distance determination unit 190 that the terminal is distant from the base station, the wireless quality (SINR) threshold determination unit 200 determines whether the value indicating the wireless quality of the RA burst measured by the wireless quality (SINR) measurement unit 170 is equal to or under the predetermined threshold. Next, the slot assignment control unit 130 controls the slot assignment by using the spatial multiplexing slot assignment algorithm (method), which will be described in detail below, with reference to the information of the maximum spatial multiplexing order determination unit 140 and the subslot management unit 150.

Next, the burst transmission unit 160 informs the terminal of a result of assignment. Here, the “full slot” has a normal slot configuration. In contrast, the “subslot” has a slot configuration dividing a “full slot” into halves to be time-shared by a pair of (two) users, for example, in need of only a narrowband such as VoIP. As a time sharing method, there may be a method which alternately uses even frames and odd frames between two users, and a method which divides a slot into a first half and a last half and uses them for two users. The full slot and the subslot will be described in detail below.

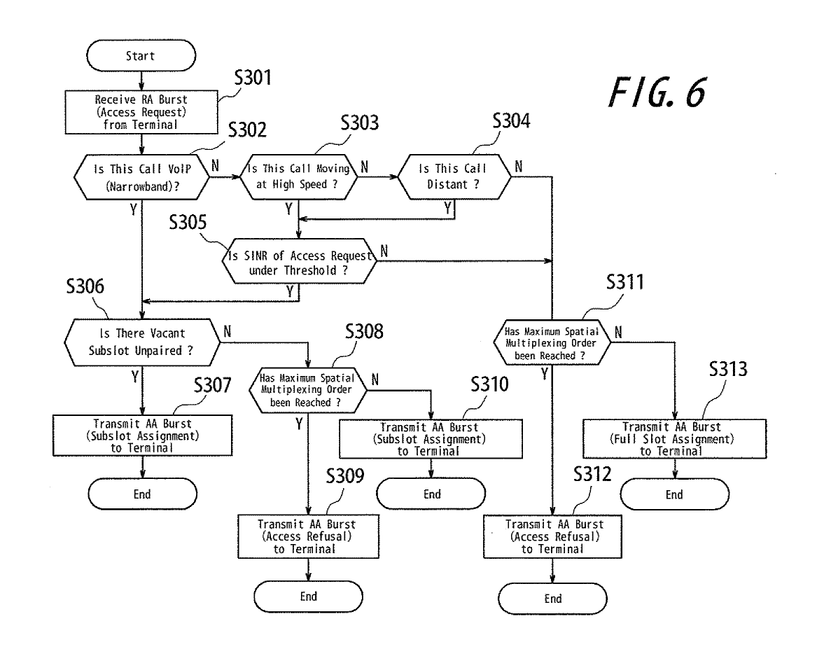

FIG. 6 is a flowchart illustrating a spatial multiplexing slot assignment algorithm (method) according to a third embodiment of the present invention. As shown in the figure, at step S301, first, the burst reception unit 110 of the base station 3 (the communication apparatus for controlling the slot assignment and the spatial multiplexing) receives the RA burst (access request) from a terminal, and the wireless quality (SINR) measurement unit 170 measures a value (for example, SINR) indicating the wireless quality of the RA burst. Next, the VoIP (narrowband call) determination unit 120 determines whether the terminal is a narrowband call terminal by reading the VoIP (narrowband call) bit pre-embedded in the RA burst (step S302). If a result of determination by the VoIP (narrowband call) determination unit 120 indicates that the terminal is not a narrowband call terminal, the high-speed movement determination unit 180 reads the high-speed movement bit pre-embedded in the RA burst and determines whether the terminal is a fast moving terminal (step S303). If a result of determination by the high-speed movement determination unit 180 indicates that the terminal is not a fast moving terminal, the distance determination unit 190 reads the distance access bit pre-embedded in the RA burst and determines whether the terminal is a distant terminal (step S304). If it is determined by the high-speed movement determination unit 180 at step S303 that the terminal is moving at a high speed or if it is determined by the distance determination unit 190 at step S304 that the terminal is distant from the base station, the wireless quality (SINR) threshold determination unit 200 determines whether the value indicating the wireless quality of the RA burst measured by the wireless quality (SINR) measurement unit 170 is equal to or under the predetermined threshold (step S305).

If it is determined at step S302 that the terminal is a narrowband call terminal or if it is determined at steps S303-S305 that the terminal is a fast moving terminal or the distant terminal and that the value of the wireless quality is equal to or under the predetermined threshold, the slot assignment control unit 130 controls to assign a subslot to the terminal. In this case, the subslot management unit 150 determines whether there is a vacant subslot unused (vacant subslot unpaired), while another subslot is used for another narrowband call, among a plurality of subslots (for example, two) in a full slot (step S306). If there is a vacant subslot unpaired, the slot assignment control unit 130 controls the burst transmission unit 160 to transmit the AA burst (subslot assignment) to the terminal to assign the vacant subslot to the terminal (step S307) and then ends the assignment algorithm processing.

If there is no vacant subslot unpaired at step S306, the maximum spatial multiplexing order determination unit 140 determines whether the carrier frequencies at reception of the RA burst from the terminal have reached the maximum spatial multiplexing order (step S308). If they have not reached the maximum spatial multiplexing order, the slot assignment control unit 130 shifts to step S310 to control the burst transmission unit 160 to transmit the AA burst (subslot assignment) to the terminal to assign any vacant subslot to the terminal and ends the assignment algorithm processing. In contrast, if it is determined at step S308 that they have reached the maximum spatial multiplexing order, the slot assignment control unit 130 controls the burst transmission unit 160 to transmit the AA burst (access refusal) to the terminal to refuse the access of the terminal (step S310) and ends the assignment algorithm processing.

If it is determined at one of steps S302-S304 that the terminal is not any of the narrowband call terminal, the fast moving terminal or the distant terminal (that is, the call from the terminal is a broadband call in need of full slot assignment), or if it is determined at steps S303-S305 that the terminal is a fast moving terminal or the distant terminal and that the value indicating the wireless quality satisfies the predetermined threshold (that is, if it is possible to assign the full slot to the fast moving terminal or the distant terminal), the maximum spatial multiplexing order determination unit 140 determines whether the carrier frequencies at reception of the RA burst from the terminal have reached the maximum spatial multiplexing order (step S311). If they have not reached the maximum spatial multiplexing order, the slot assignment control unit 130 shifts to step S313 to control the burst transmission unit 160 to transmit the AA burst (full slot assignment) to the terminal to assign the full slot to the terminal and ends the assignment algorithm processing. In contrast, if it is determined at step S311 that it has reached the maximum spatial multiplexing order, the slot assignment control unit 130 controls the burst transmission unit 160 to transmit the AA burst (access refusal) to the terminal to refuse the access of the terminal (step S312) and ends the assignment algorithm processing.

According to the present embodiment, as described above, the slot assignment is restricted such that all of communication calls from the VoIP (narrowband call) terminals with low frequency usage efficiency and from the fast moving terminals and the distant terminals having low wireless quality are assigned subslots, while other normal data user terminals are assigned full slots. Thereby, it is expected to dramatically improve the frequency usage efficiency of the entire system. Especially, since full slots are assigned to terminals with good wireless quality even if they are fast moving terminals or distant terminals, it is possible to provide users of these terminals with high wireless throughput. Accordingly, it is expected to improve the frequency usage efficiency.

In addition, according to the present embodiment, since subslots are assigned to communication calls from the fast moving terminal and the distant terminal with low wireless quality, it is possible to reduce interference with other terminals by these terminals. Accordingly, it is expected to improve the frequency usage efficiency of the entire system.

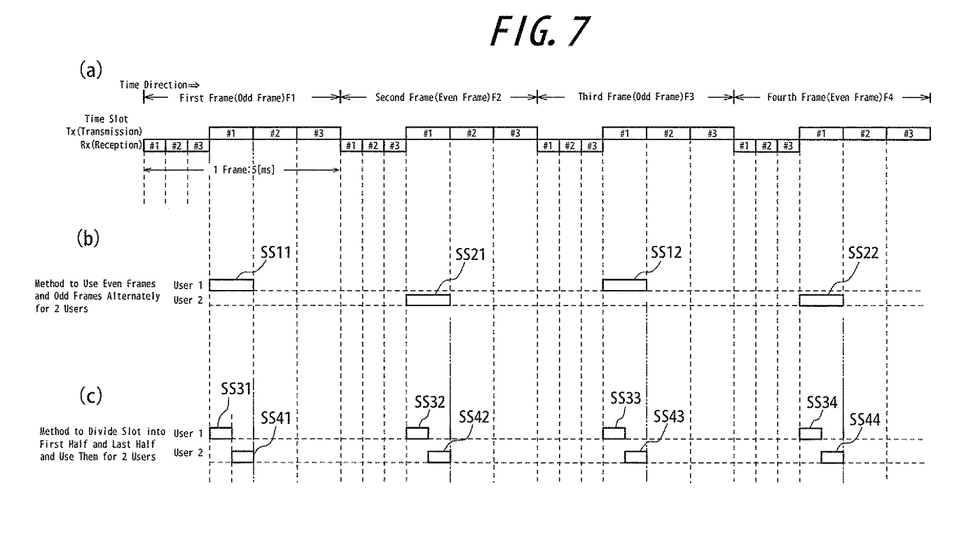

FIG. 7 is a timing chart illustrating an exemplary subslot scheme according to the present invention. FIG. 7(a) illustrates an original time slot (full slot) of the full slot scheme. From a point of view of the base station, Tx in an upper position includes time slots #1 to #3 on a transmission side and RX in a lower position includes time slots #1 to #3 on a reception side, and the time slots have asymmetric time intervals.

FIG. 7(b) illustrates dividing full slots into subslots by dividing assignment of the full slots at certain intervals of frames, such as even frames or odd frames. The slots #1 in frames F1 and F3, which are the odd frames, are assigned to a user 1 as subslot SS11 and subslot SS12, respectively. Similarly, slots #1 in frames F2 and F4, which are the even frames, are assigned to a user 2 as subslot SS21 and subslot SS22, respectively.

FIG. 7(c) illustrates dividing full slots into subslots by dividing a single time slot into a first half part and a last half part. The first half parts of the slots #1 in respective frames F1 to F4 are assigned to the user 1 as subslots SS31 to SS34, respectively. In contrast, the last half parts of the slot #1 in respective frames F1 to F4 are assigned to the user 2 as subslots SS41 to SS44. It is possible to minimize deterioration of the communication quality and a communication area caused by making subslots, by leaving the slots on the reception side having a band half of that on the transmission side as full slots and temporarily sharing slots of any user.

The adaptive array base station and the control method thereof according to the present invention, as described above, can allow access twice as many users than conventional if, for example, all accesses of the spatial multiplexing slots are communication calls of narrowband call terminals such as VoIP, distant terminals and fast moving terminals, which are assigned subslots. In addition, since full slots is assigned to broadband calls as usual until the maximum spatial multiplexing order is reached, the communication quality of the broadband call users will not be influenced by assignment of subslots to narrowband call terminals and the like.

Although the present invention is described based on figures and the embodiments, it should be appreciated that various changes and modifications will be readily apparent to those skilled in the art based on the disclosure of the present invention. Accordingly, such changes and modifications are included in a scope of the present invention. In addition, a function included in each unit, each means or each step can be rearranged avoiding a logical inconsistency, such that a plurality of means or steps are combined or divided. For example, although only a frame on the transmission side is described for assignment of subslots in the above embodiments, the same assignment can be performed for subslots on the reception side.

Moreover, although periodic division of two frames such as the odd frame and the even frame and division of one full slot into the first half and the last half are used for making subslots by dividing full slots in the above embodiments, it is also possible to divide full slots into 3, 4 or more subslots.

### REFERENCE SIGNS LIST

1, 2, 3 adaptive array base station
110 burst reception unit
120 VoIP (narrowband call) determination unit
130 slot assignment control unit
140 maximum spatial multiplexing order determination unit
150 subslot management unit
160 burst transmission unit
170 wireless quality (SINR) measurement unit
180 high-speed movement determination unit
190 distance determination unit
200 wireless quality (SINR) threshold determination unit
A1, A2, A3 control unit
ANT adaptive array antenna
SS11, SS12 subslot
SS21, SS22 subslot
SS31-SS34 subslot
SS41-SS44 subslot

1. A spatial multiplexing slot assignment method of a base station for communicating with a plurality of terminals, comprising the steps of:
receiving an access request transmitted from a terminal;
determining at least one of a state of the terminal and wireless quality of the access request based on the access request; and
controlling assignment to assign a slot to the terminal by a subslot scheme or a full slot scheme in accordance with a result of determination at the step of determining.

2. The spatial multiplexing slot assignment method according to claim 1, wherein
the step of determining comprises determining whether the access request indicates that a call of the terminal is a narrowband call, indicates that the terminal is moving at a predetermined speed or faster, or indicates that the terminal is distant from the base station by a predetermined distance or further, and
the step of controlling assignment comprises assigning a slot to the terminal by the subslot scheme if it is determined at the step of determining that the call of the terminal is the narrowband call, that the terminal is moving at the predetermined speed or faster, or that the terminal is distant from the base station by the predetermined distance or further, otherwise assigning a slot to the terminal by the full slot scheme.

3. The spatial multiplexing slot assignment method according to claim 1, wherein
the step of determining comprises determining whether the access request indicates that a call of the terminal is a narrowband call or whether a value indicating wireless quality of the access request is equal to or under a predetermined value, and
the step of controlling assignment comprises assigning a slot to the terminal by the subslot scheme if it is determined at the step of determining that the call of the terminal is the narrowband call or that the value indicating the wireless quality of the access request is equal to or under the predetermined value, otherwise assigning a slot to the terminal by the full slot scheme.

4. The spatial multiplexing slot assignment method according to claim 1, wherein
the step of determining comprises determining whether the access request indicates that a call of the terminal is a narrowband call, indicates that the terminal is moving at a predetermined speed or faster, or indicates that the terminal is distant from the base station by a predetermined distance or further, or whether a value indicating wireless quality of the access request is equal to or under a predetermined value, and
the step of controlling assignment comprises assigning a slot to the terminal by the subslot scheme
if it is determined at the step of determining that the call of the terminal is the narrowband call, or
if it is determined that the terminal is moving at the predetermined speed or faster or that the terminal is distant from the base station by the predetermined distance or further, and it is determined that the value indicating the wireless quality of the access request is equal to or under the predetermined value,
otherwise assigning a slot to the terminal by the full slot scheme.

5. The spatial multiplexing slot assignment method according to claim 1, further comprising the step of:
managing subslots, in assigning a slot to the terminal by the subslot scheme, wherein a full slot is divided into a plurality of subslots, to determine whether there is a vacant subslot unused, while a part of subslots is in use among the plurality of subslots, in spatial multiplexing slots of the base station, wherein
the step of controlling assignment comprises assigning the vacant subslot to the terminal if it is determined at the step of managing subslots that there is the vacant subslot.

6. A base station for communicating with a plurality of terminals by a spatial multiplexing slot assignment scheme comprising:
a reception unit for receiving an access request transmitted from a terminal; and
a control unit for assigning a slot to the terminal by a subslot scheme or a full slot scheme in response to the access request.

7. The base station according to claim 6, wherein
the control unit assigns a slot to the terminal by the subslot scheme if the access request indicates that a call of the terminal is a narrowband call, indicates that the terminal is moving at a predetermined speed or faster, or indicates that the terminal is distant from the base station by a predetermined distance or further, otherwise assigns a slot to the terminal by the full slot scheme.

8. The base station according to claim 6, wherein
the control unit assigns a slot to the terminal by the subslot scheme if the access request indicates that a call of the terminal is a narrowband call or if a value indicating wireless quality of the access request is equal to or under a predetermined value, otherwise assigns a slot to the terminal by the full slot scheme.

9. The base station according to claim 6, wherein the control unit assigns a slot to the terminal by the subslot scheme
if the access request indicates that a call of the terminal is a narrow band call, or
if the access request indicates that the terminal is moving at a predetermined speed or faster or indicates that the terminal is distant from the base station by a predetermined distance or further, and a value indicating wireless quality of the access request is equal to or under a predetermined value,
otherwise assigns a slot to the terminal by the full slot scheme.

10. The base station according to claim 6, wherein
the control unit, in assigning a slot to the terminal by the subslot scheme, wherein a full slot is divided into a plurality of subslots, if there is a vacant subslot unused while a part of subslots is in use among the plurality of subslots, in spatial multiplexing slots of the base station, controls to assign the vacant subslot to the terminal.

11. The spatial multiplexing slot assignment method according to claim 2, further comprising the step of:
managing subslots, in assigning a slot to the terminal by the subslot scheme, wherein a full slot is divided into a plurality of subslots, to determine whether there is a vacant subslot unused, while a part of subslots is in use among the plurality of subslots, in spatial multiplexing slots of the base station, wherein
the step of controlling assignment comprises assigning the vacant subslot to the terminal if it is determined at the step of managing subslots that there is the vacant subslot.

12. The spatial multiplexing slot assignment method according to claim 3, further comprising the step of:
managing subslots, in assigning a slot to the terminal by the subslot scheme, wherein a full slot is divided into a plurality of subslots, to determine whether there is a vacant subslot unused, while a part of subslots is in use among the plurality of subslots, in spatial multiplexing slots of the base station, wherein
the step of controlling assignment comprises assigning the vacant subslot to the terminal if it is determined at the step of managing subslots that there is the vacant subslot.

13. The spatial multiplexing slot assignment method according to claim 4, further comprising the step of:
managing subslots, in assigning a slot to the terminal by the subslot scheme, wherein a full slot is divided into a plurality of subslots, to determine whether there is a vacant subslot unused, while a part of subslots is in use among the plurality of subslots, in spatial multiplexing slots of the base station, wherein
the step of controlling assignment comprises assigning the vacant subslot to the terminal if it is determined at the step of managing subslots that there is the vacant subslot.

14. The base station according to claim 7, wherein
the control unit, in assigning a slot to the terminal by the subslot scheme, wherein a full slot is divided into a plurality of subslots, if there is a vacant subslot unused while a part of subslots is in use among the plurality of subslots, in spatial multiplexing slots of the base station, controls to assign the vacant subslot to the terminal.

15. The base station according to claim 8, wherein
the control unit, in assigning a slot to the terminal by the subslot scheme, wherein a full slot is divided into a plurality of subslots, if there is a vacant subslot unused while a part of subslots is in use among the plurality of subslots, in spatial multiplexing slots of the base station, controls to assign the vacant subslot to the terminal.

16. The base station according to claim 9, wherein
the control unit, in assigning a slot to the terminal by the subslot scheme, wherein a full slot is divided into a plurality of subslots, if there is a vacant subslot unused while a part of subslots is in use among the plurality of subslots, in spatial multiplexing slots of the base station,
controls to assign the vacant subslot to the terminal.
